(19) United States
(12) Patent Application Publication
(10) Pub. No.: US 2016/0357812 A1
(43) Pub. Date: Dec. 8, 2016

(54) SYSTEM AND METHOD FOR TRANSFORMING AND COMPRESSING GENOMICS DATA

(71) Applicants: Daniel Greenfield, Cambridge (GB); Alban Rrustemi, Cambridge (GB)

(72) Inventors: Daniel Greenfield, Cambridge (GB); Alban Rrustemi, Cambridge (GB)

(21) Appl. No.: 15/155,902

(22) Filed: May 16, 2016

(30) Foreign Application Priority Data
May 14, 2015 (GB) 1508314.0

(51) Int. Cl. G06F 17/30; G06N 7/00

(52) U.S. Cl. CPC G06F 17/30442; G06N 7/005; G06F 17/30483

(57) ABSTRACT

This invention relates to the quality scores of bases produced from high throughput genomic sequencing, in particular to transforming the quality scores for improved compressibility. A method for transforming these quality scores is described whereby a quality score is modified by utilising a Bayesian model based on Coding Theory combined with search results from a genomic corpus. A related method is described for efficient searching for a Read in a genomic corpus so as to find all matching symbols up to a given Hamming-distance or Edit-distance.

### TECHNICAL FIELD

The present disclosure relates to methods of transforming and compressing genomics data, in particular to quality score values of sequencing data. More specifically, the present disclosure concerns a method of using Bayesian probability and Coding theory to boost high throughput sequencing quality score information. The present disclosure concerns the use of this method in compressing information that contains or is related to gene sequences. Furthermore, the present disclosure relates to software products recorded on machine readable data storage media, wherein the software products are executable on computing hardware for implementing aforesaid methods.

### BACKGROUND

An approach incorporating insights from Coding Theory is used to boost the signal of bases in High Throughput Sequencing (HTS) outputs according to a conservative prior and Bayesian model. The resultant boosted quality scores are a more accurate representation of the confidence of base calls in each Read, and can be better compressed. Unlike lossy compression schemes that approximate or throw out quality score information, the quality scores from this approach are boosted according to a robust and conservative Coding Theory model. The side-effect is that most quality scores are pushed beyond the saturation point of the Phred scheme resulting in high compression ratios. Importantly, this Bayesian approach does not modify the quality scores of bases unless there is a robust statistical basis for doing so. Instead it improves the underlying quality score of the HTS data under a conservative prior, with improved compression as a side-effect.

In the ordinary case, Coding Theory describes how one can communicate symbols over a noisy communication channel to recover the original symbol. Applying Coding Theory allows one to practically separate out signal from noise utilising a Bayesian approach. The Hamming Distance is used to determine the likelihood that the signal received on the other end corresponds to one symbol versus another. The larger the Hamming Distance between all other symbols, the more likely it is that a symbol can be recovered on the other end and separated from noise. Indeed, the ability of a symbol to tolerate and separate noise grows exponentially with its Hamming Distance to other symbols.

Therefore, there exists a need for an improved method for transforming quality scores of bases in genomic sequences, in order to improve the quality and compressibility of data.

### SUMMARY

According to a first aspect of the invention there is provided a method of transforming quality scores of bases in a Read of sequence data so as to improve compressibility of quality score data. The method comprises determining a distance to search in a genomic corpus; performing a search using the Read on the given corpus with the given distance; performing calculations based on search results to adjust the quality scores of bases in the Read. Optionally, a fixed value of the search distance can be pre-selected and used instead of determining a distance to search.

In preferred embodiments of this method, the search is based on a Hamming-distance or edit-distance search.

In preferred embodiments of this method, quality scores are adjusted using a calculation that utilises a Bayesian estimation of the likelihood that a base in the read has a sequencing error.

Optionally, the calculation in the method utilises the existing quality score of the genomic sequence base that is specified in the genomic sequence read.

Optionally, the calculation in the method utilises estimations of the probability of mutation between the corpus and the sample underlying the genomic sequence read.

In preferred embodiments of this method, the corpus includes a reference genome for the genomic sequence read.

According to a second aspect of the invention, there is provided a method for partitioning a sequence read into a multiplicity of slots, the number of slots being determined based on the search distance, and performing a lookup operation on each said slot into a corpus. The candidate results from each said slot are finally combined together.

In preferred embodiments of this method, the determination of the number of slots utilises the Pigeonhole Principle.

In preferred embodiments of this method, the combined results are filtered so as to exclude those not within the determined search distance.

In preferred embodiments of this method, the lookup operation is performed according to an index for candidates within the corpus.

In other embodiments of this method, the slots are not required to have a fixed width.

In other embodiments of this method, the index contains a primary index, and where the lookup operation involves partitioning the slot into a fixed-width primary search key and non-fixed width secondary search key; utilising the primary index and primary key for the primary search, the result of which is then utilised for the secondary search using the secondary search key. The secondary search can optionally utilise a binary traversal of sorted values to find matching candidates.

### DESCRIPTION OF THE DIAGRAMS

Embodiments of the present disclosure will now be described, by way of example only, with reference to the following diagrams wherein:

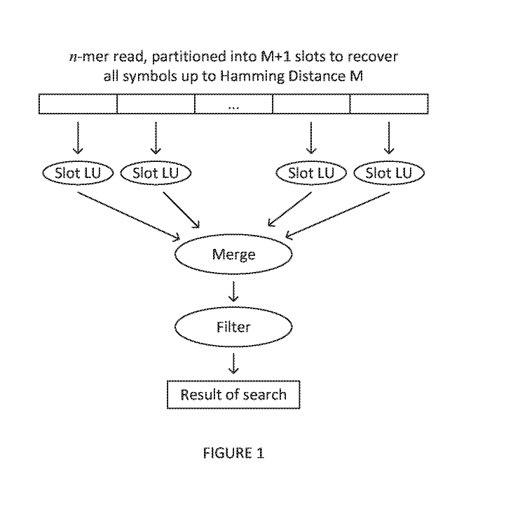

FIG. 1 is a schematic illustration of dividing a symbol search into multiple slot lookup searches

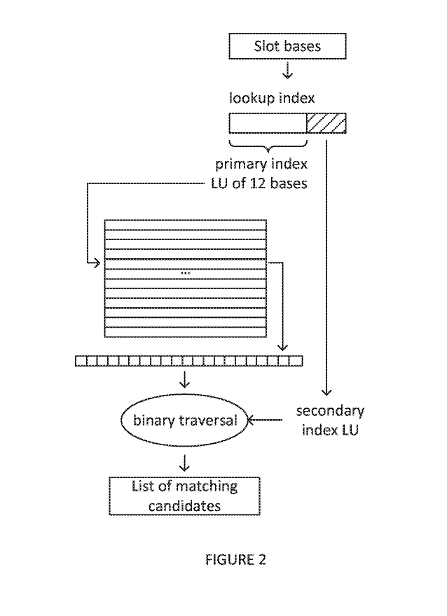

FIG. 2 is a schematic illustration of an individual slot lookup search

### DETAILED DESCRIPTION OF EMBODIMENTS

In an embodiment, HTS can be recast and modelled utilising Coding Theory. The transmission model can be based on symbols originating (transmitted) from a corpus (for humans, the corpus may simply be the human reference genome but can be any other representative human genome corpora) that undergoes noise in the form of mutations to form the sample genome, which then undergoes sequencing that introduces further noise in the form of Read errors the result of which is the raw sequencing data (received symbols). In this case the noisy medium has two parts—mutation and sequencing. In the first instance, this approach can ignore indels (insertions and/or deletions—as mutations or as a source of Read errors). For the human genome, the dominant source of variation is due to base changes rather than indels, and the dominant error in Illumina sequencing machines is due to misread bases rather than indels. Thus the type of noise can be considered to primarily be due to base changes, however indels can also be handled in the extended instance.

A Reference Genome (or corpus in general) is considered, which due to mutation with probability m forms a Sample Genome (this could be the genome of a particular individual that is sequenced). From this Sample Genome multiple n-mers are randomly constructed which are then sequenced with error probability ε to form a Read. Each of these n-mers can be cast back to an equivalent n-mer on the Reference Genome. Reference Genome n-mers can represent our collection of symbols, and the noisy medium encapsulates the errors introduced at all the stages up to producing the Read. Conservative values are used for each of these stages. The medium has a combined noise probability of μ≡m+ε− 4/3mε. To a first order this is merely the sum of the individual error processes (m+ε), but to a second order it can also take into account mutations that have been incorrectly sequenced as the original unmutated version.

One can construct ˜3.2 billion symbols of n-mers from the ˜3.2 billion bases in the human genome. If these bases were truly random, the average Hamming symbol distance would be expected to be ¾n for any n-mer. However, the human genome is most certainly not random. To overcome this, the treatment of nearby symbols is separated from more distant background symbols. Upon transmitting a symbol, the probability that it would arrive as a particular symbol with Hamming Distance B is:

μ^{B}(1−μ)^{n . . . B}

Naming Convention:

n—number of bases in a Read (may vary from Read to Read)

S—an n-mer Read symbol

Rₖ—reference n-mer symbol k

Gₖ—true Sample Genome n-mer symbol k

Sⱼ—base j of n-mer Read

εⱼ—Read error for base j of n-mer Read

Rₖⱼ—base j of reference symbol k

Gₖⱼ—base j of true Sample Genome symbol k

Zⱼ—base j of true Sample Genome source symbol corresponding to the Read

The symbol S corresponds to an n-mer Read. Rₖ is generated from a reference genome by enumerating all possible n-mers from this reference. It is assumed that there is a true Sample Genome that is derived from the reference genome according to a mutation process with per-base probability of mutation m. Let Gₖ be the matching enumeration of all possible n-mers from this Sample Genome.

Based on a Markovian mutation process M (with probability m) and Read error process E (with probability ε):

$$Pr ( {S}_{j} \vert {R}_{kj} ) = \{ \begin{matrix}( 1 - m ) ( 1 - {ε}_{j} ) + \frac{1}{3} m {ε}_{j} & if {S}_{j} = {R}_{kj} \\ ( 1 - m ) {ε}_{j} + m ( 1 - {ε}_{j} ) + \frac{2}{3} m {ε}_{j} & if {S}_{j} \neq {R}_{kj}\end{matrix} \\ Pr ( S \vert {R}_{k} ) = {\prod }_{j} Pr ( {S}_{j} \vert {R}_{kj} )$$

The Bayes' theorem gives:

$$\begin{matrix}Pr ( {R}_{k} \vert S ) = \frac{Pr ( S \vert {R}_{k} ) Pr ( {R}_{k} )}{{\sum }_{i} Pr ( S \vert {R}_{i} ) Pr ( {R}_{i} )} \\ = \frac{Pr ( S \vert {R}_{k} )}{{\sum }_{i} Pr ( S \vert {R}_{i} )}\end{matrix}$$

$$With \text{:} Pr ( {R}_{k} ) = \frac{1}{N}$$

for N possible n-mers, corresponding to uniform sequencing of a genome.

Moreover given a particular Rₖ and S, the probability that a base Sⱼ mismatches the source symbol from the Sample Genome corresponding to the Read Zⱼ (i.e. is a Read error) can be determined according to:

$$Pr ( {S}_{j} \neq {Z}_{j} \vert S , {R}_{k} ) = \{ \begin{matrix}\begin{matrix}m {ε}_{j} \\ 3 - 3 m - 3 {ε}_{j} + 4 m {ε}_{j}\end{matrix} & if {S}_{j} = {R}_{kj} \\ \frac{{ε}_{j} ( 3 - m )}{3 {ε}_{j} + 3 m - 4 m {ε}_{j}} & if {S}_{j} \neq {R}_{kj}\end{matrix}$$

Then, removing the dependence on Rₖ, we can determine the Read error per base as:

$$\begin{matrix}Pr ( {S}_{j} \neq {Z}_{j} \vert S ) = {\sum }_{k} Pr ( {S}_{j} \neq {Z}_{j} \vert S , {R}_{k} ) Pr ( {R}_{k} \vert S ) \\ = \frac{{Σ}_{k} Pr ( {S}_{j} \neq {Z}_{j} \vert S , {R}_{k} ) Pr ( S \vert {R}_{k} )}{{Σ}_{i} Pr ( S \neq {R}_{i} )}\end{matrix}$$

With ˜3.2 billion symbols, this calculation is resource intensive if completed by brute force. By recognising that the contribution of reference symbols decreases exponentially according to their Hamming distance from the Read symbol, this operation can be sped up with negligible error. Let L denote the set of local indices s.t.

∀k∈L, |Rₖ−S|<B

∀k∉L, |Rₖ−S|≧B

for some Hamming Distance B. The choice of B is ideally such that:

$${\sum }_{i ∉ L} Pr ( S \vert {R}_{i} ) ≪ m ε {\sum }_{i ∈ L} Pr ( S \vert {R}_{i} )$$

$$Then \text{:}$$

$$Pr ( {S}_{j} \neq {Z}_{j} \vert S ) \approx \frac{{Σ}_{k ∈ L} Pr ( {S}_{j} \neq {Z}_{j} \vert S , {R}_{k} ) Pr ( S \vert {R}_{k} )}{{Σ}_{i ∈ L} Pr ( S \vert {R}_{i} )}$$

There are

$${3}^{B} ( \begin{matrix}n \\ B\end{matrix} )$$

possible symbols Xₖ at distance B. To obtain an estimate β for the background contribution, the average probability of these symbols Pr(S|Xₖ) is normalised to N symbols, leading to a value that is typically a very large overestimate and thus conservative in practice:

β=Nμ^{B}(1−μ)^{n-B}

Therefore, a conservative overestimate of each base's Read error can be represented with:

$$Pr ( {S}_{j} \neq {Z}_{j} \vert S ) \approx \frac{{Σ}_{k ∈ L} Pr ( {S}_{j} \neq {Z}_{j} \vert S , {R}_{k} ) Pr ( S \vert {R}_{k} ) + \frac{{ε}_{j} ( 3 - m )}{3 {ε}_{j} + 3 m - 4 m {ε}_{j}} β}{{Σ}_{i ∈ L} Pr ( S \vert {R}_{i} )}$$

This estimate of a base's Read error represents the new, boosted quality score for the base upon conversion using the Phred scheme:

Q=10log₁₀P

Where Q is the Phred quality score for an error probability of P.

For each Read, the initial distance to search is dependent on the expected error rate and the length of the Read so that longer reads may need larger search distances. For example one may use a search distance based on the worst case Read error ε plus some margin multipler (e.g. 2n(ε+m)). Since the maximum width of a slot may be constrained (say to 32 bases), this may also place a constraint on the minimum distance that can be searched (to in this case ┌n/32┐−1). Likewise the background error may be excessive if the search distance is too low, so a minimum distance (e.g. of 5) may also be applied.

Further, the present disclosure is associated with following exemplary methods:

### A) Symbol Search

To find all symbols with up to M mismatches from the read, the read is divided into M+1 slots. Based on the Pigeonhole principle, for any symbol up to Hamming distance M away, there must be one slot that does not contain a mismatch (i.e. is an exact match). All slots are searched for all matching symbols. If a particular slot, for example, is a k-mer, a search is made to find all symbols that contain that particular k-mer. The union of searches across the slots is then guaranteed to contain at least all those symbols within the desired Hamming distance M, however it can also contain candidate symbols that are greater than this distance. Filtering is used to discard symbols that are greater than distance M. The per-slot search (Slot LU in FIG. 1) can be achieved by first indexing the reference sequence/corpus according to overlapping k-mers as a pre-processing step (e.g. if the corpus contains ACGGCTAC at some position 1004 then a 6-mer index for that would contain position 1004 at index ACGGCT and position 1005 at index CGGCTA and position 1006 at index GGCTAC). For each slot, the set of possible matching symbols is then easily determined by looking up the index for match positions in the corpus. It can be noted that the larger the slot width, the more specific the slot search, and the fewer the possible candidate symbols that need to be examined.

For performance reasons, therefore, it is desirable to have wide slots for searching. However, sometimes more narrow slots are desired (e.g. if searching smaller reads or larger Hamming distances). The following flexible indexing mechanism allows this freedom. For each overlapping k>12 bases, a 24-bit (2-bits per base) primary index is generated from the first 12 bases. For each primary index, the starting position is stored in the reference genome/corpus to the index along with a secondary index of the remaining (k−12) bases. For example, a secondary index of 8 bits enables 4 additional bases to be stored, resulting in a combined 16 base index, so that a string CTATCGGCTCACTGGA would have a primary index of CTATCGGCTCAC and a secondary index of TGGA. Similarly, a secondary index of 32 bits enables a 28 base index (12 primary+16 secondary). Within each primary index, the entries are sorted according to the secondary index. When searching a slot width of size 12 then, only the primary index is used, and all offsets are retrieved within that index. However when searching a slot width of say size 15, the secondary index is also used to, via binary traversal, retrieve only those offsets that match the additional 3 bases. When searching a slot width that is greater than both the full index size, say of 30 bases when only a 16 base full index is available, then this is achieved by determining the intersection of overlapping 16-base index searches (e.g. a search of CTATCGGCTCACTGGAGCTAACCGATCGAT would consist of a search of CTATCGGCTCACTGGA and GAGCTAACCGATCGAT each represented by slot lookup search, followed by an intersection operation on the results). This methodology allows for rapid and flexible searching of reads within a desired Hamming distance across the reference corpus.

A further speedup can be achieved by making use of the secondary index even when the slot search width is narrow. This is done by directly determining the Hamming distance from the difference between the secondary index and the corresponding section of the Read. If the Hamming distance exceeds the search distance, then we know that this candidate symbol does not meet the search criteria and can be discarded early (rather than at the filtering stage). This saves on random accesses to the reference genome/corpus, resulting in fewer expensive cache misses. In this case, extra bases beyond the slot are also passed to the Slot LU operation (up to a combined size of the full index) to leverage this early filtering operation. For example, a 12-mer slot search of CTATCGGCTCAC where the full index is 20 bases and the Hamming search distance is 3, the slot search operation can be provided the extra 8 bases TGGAGCTA that immediately follow the slot search bases. When determining the list of candidates, instead of adding all items that match the 12-mer search, the secondary index of a candidate can be compared against the extra provided bases to see if it has a Hamming distance of 4 or more, and to thus conditionally exclude candidates.

### B) Read Processing

Because a Read may have poor quality scores (high errors) at the head and tail of the Read, a simple preprocessing step involves truncating the Read on either side according to a maximum tolerable quality score (e.g. a probability of Read error of 10% or higher). This truncated result is only used for feeding into the analysis pipeline, and the original Read is not itself truncated.

### C) Quality Score Quantisation

Boosted quality scores may be improved to such an extent that they represent negligible error. Such quality scores can be constrained to a maximum saturation value S (e.g. 40) beyond which they cannot be further boosted. Those quality scores that are boosted from a value x to a non-saturation value y<S may instead of recording the value y, use a quantised value y′=f(y) (e.g. based on the Illumina 8-bin quantisation values) provided y′>x. This means that the resultant quality scores are conservatively quantised with the boosting, leading to higher compression ratios.

### D) Edit-Distance Searches

Reads with indel (base insertion or deletion) variants that are not present in the corpus are likely to result in large Hamming distances to the corpus. This means that it is highly unlikely for such reads to be successfully boosted this way, thus preserving their original quality scores. It is possible to replace Hamming distance searches of a corpus with edit-distance searches instead. An edit-distance search can incorporate a model of both in-place mutations/Read-errors as well as indels. In this case the Markov model from Rₖ to Gₖ, could incorporate the in-place mutation rate m_{B} as well as an insertion rate m_{I} and deletion rate m_{D} as processes. The sequencing Read error would still be based on the values from the actual Read, however additional estimations of the sequencer insertion error rate ε_{I} and deletion rate ε_{D} could be incorporated as well. Edit-distances searches can be done by again utilising the Pigeonhole principle, but this time accounting for indels as well.

Systematic sequencer indels affecting a whole flow-cycle of base reads (such as for Pacific Bioscience sequencers) could also be modelled with a Bayesian approach across affected reads, or by directly incorporating flow-cycle error information into the estimated indel error rates that vary per base across the read.

### E) Long Reads

For long reads (such as those that are thousands of bases long), it may be impractical to process the entire Read at once, so the Read itself could be split into smaller (fixed or variable width) subreads that themselves may benefit from the boosting process. The long Read may then be assembled from the boosted result of these subreads. In some conditions, this can lead to faster and better results than directly applying boosting on the long Read itself. The average amount that quality scores are boosted grows according to the length of the Read being boosted, however this also increases the probability of an indel being encountered and for Hamming-based searches can thus result in little or no boosting. Moreover, there is no point boosting quality scores beyond the saturation threshold. Thus a criteria for determining the split length can be according to both keeping the likelihood of encountering an indel low (<1%) for each subread, as well maintaining a length that ensures most quality scores in the subread are boosted to the saturation threshold. For searches based on edit-distance, the likelihood for encountering indels can be higher and thus longer subreads may still be appropriate, however the likelihood of encountering larger indel regions or of structural variation may still need to be kept low.

Each of the methods A, B, C, D, E and F can be used separately or in combination with each other.

### Analysis Pipeline

Steps:
1. A pre-processing step of taking a reference genome or other corpus to generate a (dynamic) index
2. For each Read
2.1. determine a suitable Hamming distance for the search
2.2. finding all symbols in the corpus within that search distance as candidate source symbols
2.3. using Bayes for determining the likelihood of candidate source symbols
2.4. estimating the contribution of all other background source symbols (including assuming zero contribution)
2.5. using these estimations to calculate a new quality score per base, optionally quantizing based on say worst-case Illumina 8-bin quantisation levels
2.6. adjusting quality scores based on new calculated quality scores—for example only if a new quality score is better than as old quality score should one replace the quality score with the new quality score
3. Optionally, to be even more conservative and minimise any possible bias:
3.1. process all reads against symbol set to find all positions where there are mismatches. Mark these mismatches in the symbol set (e.g. for a reference genome corpus, mark positions in the reference genome that correspond to mismatches)
3.2. then for each Read, ensure quality scores are preserved at these mismatch positions

### DETAILED DESCRIPTION OF FIGURES

Referring now to FIG. 1, shown is a schematic illustration of the steps in a search operation of distance up to M. Here an n-mer read is partitioned into M+1 slots, each slot is looked up with a Slot LU operation, the results from which are merged together to form a list of candidate symbols. This is then filtered to include only candidate symbols that are of distance greater than M, which then forms the list of results.

Referring now to FIG. 2, shown is a schematic illustration of the Slot LU operation from FIG. 1. Here the input slot bases are partitioned into an input primary index and an input secondary index. The input primary index is used to lookup the primary index table to obtain a list of candidates (each element in the list consists of (i) an offset in the corpus corresponding to candidate symbols, and (ii) secondary index information). The input secondary index is then used to do binary traversal of this list according to its secondary index information, so as to retrieve a subset of the list of candidates that match at least a portion of the input secondary index.

1. A method for adjusting a quality score of a genomic sequence base in a genomic sequence read, the method comprising:
determining a distance to search in a genomic corpus for a genomic sequence read;
performing a search using said read on said genomic corpus with said distance; and
based on results of said search performing calculations to adjust said quality score of said genomic sequence base in said read.

2. A method for adjusting the quality score as claimed in claim 1 wherein said search is based on a Hamming-distance or edit-distance search.

3. A method for adjusting the quality score as claimed in claim 1 wherein said calculation utilises a Bayesian estimation of the likelihood that a base in the read has a sequencing error.

4. A method as claimed in claim 1 wherein said calculation utilises the existing quality score of the said genomic sequence base in said genomic sequence read.

5. A method as claimed in claim 3 wherein said calculation utilises estimations of the mutation between the corpus and the sample underlying said genomic sequence read.

6. A method as claimed in claim 4 wherein said corpus includes a reference genome for said genomic sequence read.

7. A method as claimed in claims 1 wherein said determination of search distance is a fixed value.

8. A method for searching a genomic sequence read into a genomic corpus, the method comprising:
partitioning said genomic sequence read into a multiplicity of slots;
performing a lookup operation on each said slot into said genomic corpus, combining candidate results from each said slot.

9. A method as claimed in claim 7, wherein said determination of number of slots utilises the Pigeonhole Principle.

10. A method as claimed in claim 7 wherein said combined results are filtered so as to exclude those not within the said search distance.

11. A method as claimed in claim 7 wherein said lookup operation is performed according to an index for candidates within said corpus.

12. A method as claimed in claim 10 wherein said slots are not required to have a fixed width.

13. A method as claimed in claim 11, wherein said index contains a primary index, the method comprising:
the said lookup operation involves partitioning said slot into a fixed-width primary search key and non-fixed width secondary search key;
performing a primary search by utilising said primary search key in said primary index;
performing a secondary search by utilising the search results from said primary search, using said secondary search key.

14. A method as claimed in claim 12, wherein said secondary search utilises a binary traversal of sorted values to find matching candidates.

15. (canceled)

16. A method for adjusting a quality score of a genomic sequence base in a genomic sequence read, the method comprising:
determining a distance to search in a genomic corpus for a genomic sequence read;
performing a search using said read on said genomic corpus with said distance by:
partitioning said genomic sequence read into a multiplicity of slots; and
performing a lookup operation on each said slot into said genomic corpus, combining candidate results from each said slot; and
based on results of said search, performing calculations to adjust said quality score of said genomic sequence base in said read.


SEQUENCE LISTING (1 sequence)

SEQ ID NO: 1 - DNA, 30 bp, Unknown
  synthetic sequence
ctatcggctcactggagctaaccgatcgat